(19) United States
(12) Patent Application Publication
(10) Pub. No.: US 2005/0188900 A1
(43) Pub. Date: Sep. 1, 2005

(54) V1

(76) Inventor: Michael Sean Dittrich, Queensbury, NY (US)

Correspondence Address: Michael Sean Dittrich, 512 Ridge Road, Queensbury, NY, 12804, US

(21) Appl. No.: 10/788,196

(22) Filed: Feb. 27, 2004

(51) Int. Cl. A47B 37/00; B26D 5/08

(52) U.S. Cl. 108/50.02

(57) ABSTRACT

The V1 is a radical piece of indoor furniture. The V1 is indoor furniture designed to solve problems concerning computer hardware placement. The V1 is designed to center a persons body to an optimal position for enjoyment in computer gaming and multimedia. The V1 is designed for a persons maximum comfort. The V1 is designed for entertainment purposes.

### CROSS-REFERENCE TO RELATED APPLICATIONS

Not Applicable

### STATEMENT REGARDING FEDERALLY SPONSORED RESEARCH OR DEVELOPMENT

Not Applicable

REFERENCE TO SEQUENCE LISTINGS, A TABLE, OR A COMPUTER PROGRAM LISTING COMPACT DISK APPENDIX

Not Applicable

### BACKGROUND OF THE INVENTION

The V1 is an invention that pertains to several technical fields. The V1 pertains to the fields of furniture making, metal fabrication, and metal finishing. The V1 pertains to the fields of computer gaming and multimedia entertainment. The V1 is intended to solve previous problems with human comfort and interactions with computer hardware and multimedia.

### BRIEF SUMMARY OF THE INVENTION

The V1 is essentially a radical piece of indoor furniture. The V1 is a new concept pertaining to the way a human being interacts with computers and multimedia equipment. The V1 is designed to solve problems concerning computer hardware placement. The V1 is designed to provide placement for speakers in an optimal position. The V1 is designed to center a person's body to an optimal position to enjoy the technologies of todays computer hardware. The V1 is designed for a person's maximum comfort. The V1 is designed for entertainment and is not designed to be an ergonomic solution for pain sufferers.

### BRIEF DESCRIPTION OF THE SEVERAL VIEWS OF THE DRAWINGS

FIG. 1A: This is a perspective view of the V1. The perspective view shows the frame and tops. The V1 is designed so that most car seats will bolt to the frame. A car seat is not a part of the invention.

FIG. 1B: This is the side view of the V1. The table top and the foot rest pivot.

FIG. 1C: This is the front view of the V1.

FIG. 1D: This is the back view of the V1. The drilled holes are for wire routing.

FIG. 1E: This is the top view of the V1. The elbow rests pivot outward.

FIG. 1F: This is the bottom view of the V1. The V1 is assembled from 13 separate pieces. The unit is bolted together with 16 common ⅜″ nuts, bolts, and washers. The table tops are screwed in place with small screws. The elbow rests pivot 45 degrees. The steel tubes rest in a piece of 5″ angle iron and a ⅜″ bolt is welded in a permanent place at the pivot point.

FIG. 2A: This is the bottom view of the base of the V1.

FIG. 2B: This is the base top view of the V1.

FIG. 2C: This is the base side view of the V1.

FIG. 3A: This is the base back view of the V1.

FIG. 3B: This is the base front view of the V1.

FIG. 4A: This is the front view of the arm support of the V1.

FIG. 4B: This is the side view of the arm support of the V1.

FIG. 5A: This is the bottom view of the arm rest of the V1.

FIG. 5B: This is the top view of the arm rest of the V1.

FIG. 5C: This is the front view of the arm rest of the V1.

FIG. 5D: This is the side view of the arm rest of the V1.

FIG. 6A: This is the back view of the monitor support of the V1.

FIG. 6B: This is the side view of the monitor support of the V1.

FIG. 6C: This is the front view of the monitor support of the V1.

FIG. 6D: This is the top view of the monitor support of the V1.

FIG. 7A: This is the side view of the speaker support arm of the V1.

FIG. 7B: This is the front view of the speaker support arm of the V1.

FIG. 7C: This is the top view of the speaker support arm of the V1.

FIG. 8A: This is the top view of the main table top of the V1.

FIG. 8B: This is the side view of the main table top of the V1.

FIG. 8C: This is the top view of the circle table top of the V1.

FIG. 8D: This is the side view of the circle table top of the V1.

FIG. 8E: This is the top view of the elbow rest table top of the V1.

FIG. 8F: This is the side view of the elbow rest table top of the V1.

FIG. 9A: This is the back view of the foot rest of the V1.

FIG. 9B: This is the side view of the foot rest of the V1.

FIG. 10A: This is the back view of the flat screen support of the V1.

FIG. 10B: This is the side view of the flat screen support of the V1.

FIG. 10C: This is the front view of the flat screen support of the V1.

FIG. 10D: This is the top view of the flat screen support of the V1.

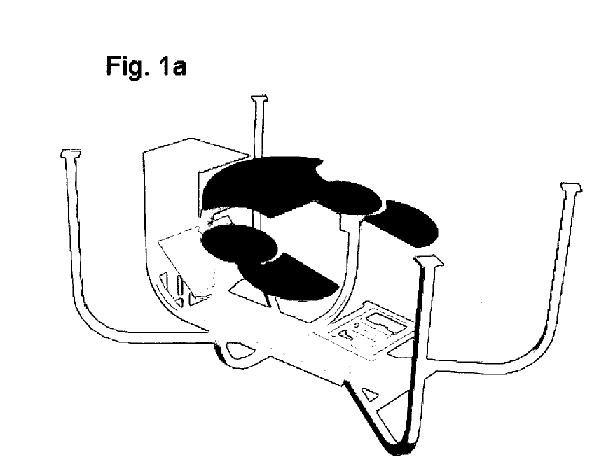

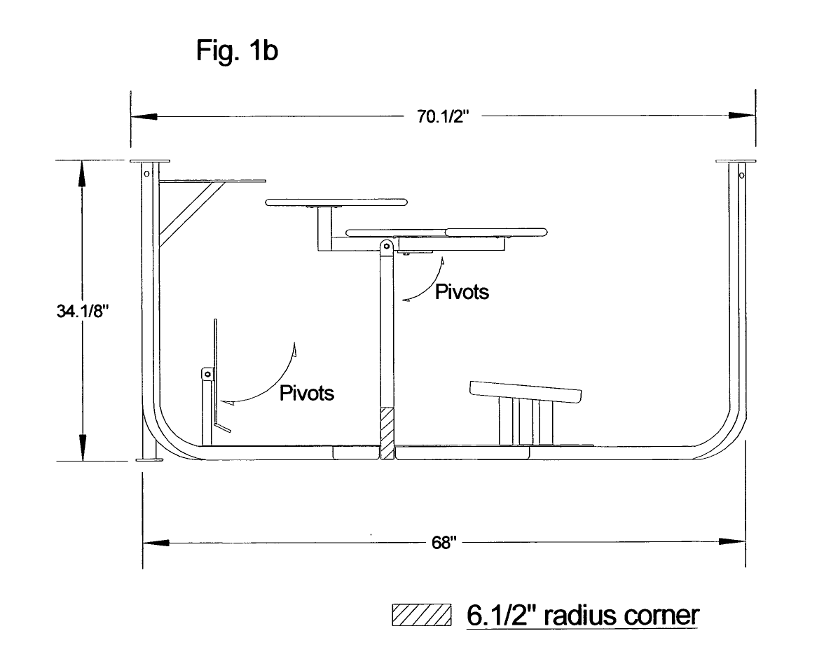

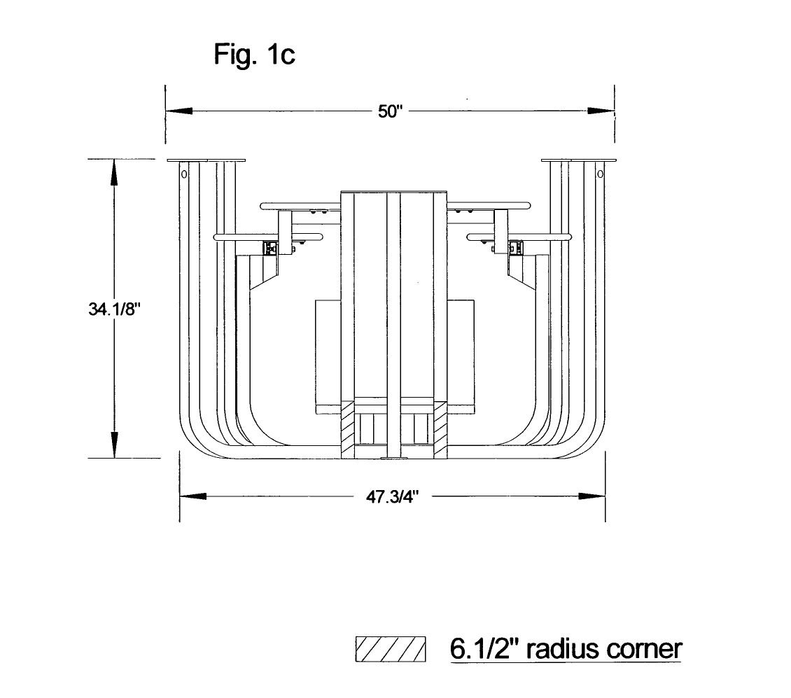

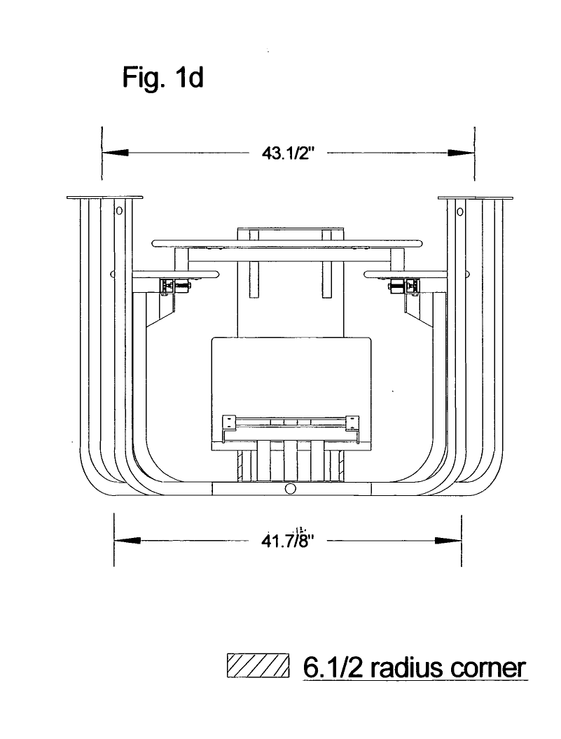

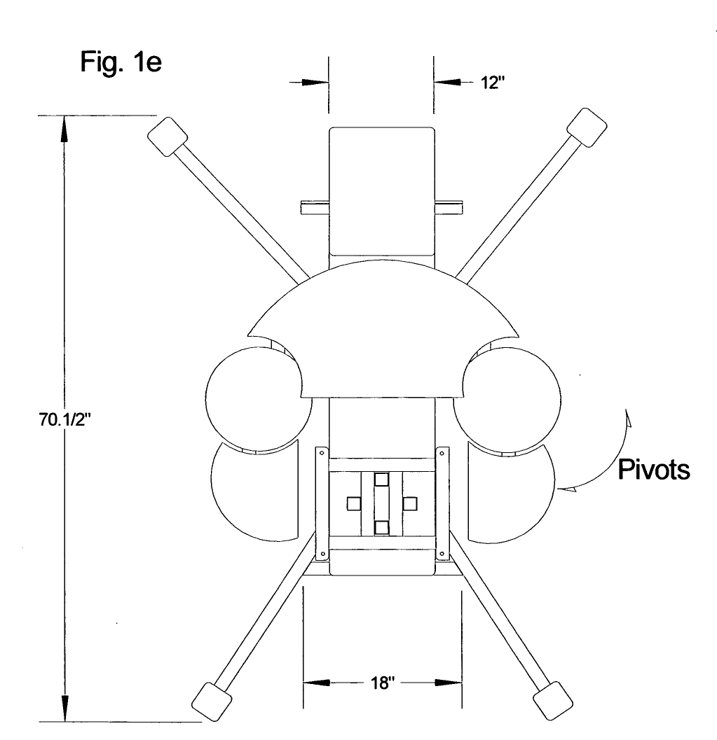

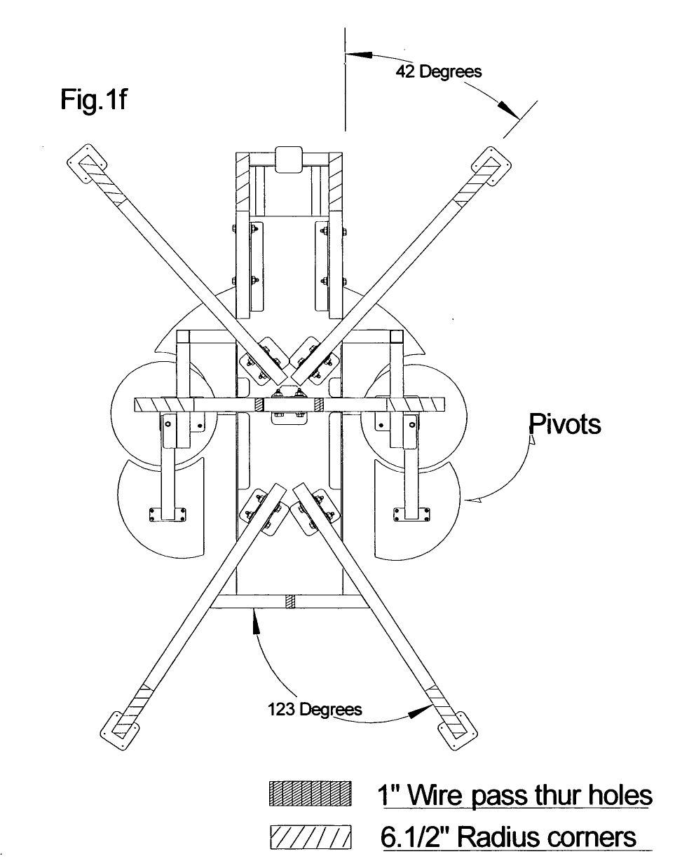

### DETAILED DESCRIPTION OF THE INVENTION

The V1 is a radical piece of indoor furniture. The V1 is a new concept pertaining to the way human beings interact with computers and multimedia equipment. The V1 is intended to be used by a person for entertainment or work purposes. The V1 is designed to center a person's body to an optimal position to enjoy the technologies of todays computer hardware. The V1 is not designed to be an ergonomic solution to pain sufferers. A person uses the V1 for computer gaming, music entertainment, and watching movies. The V1 was designed to solve problems with personal comfort and computer hardware placement.

This is a detailed description of how I make the V1. It is a somewhat complicated explanation and the drawings provided should be viewed while reading this description.

The following five paragraphs describe the preparatory cutting of the mild steel stock for the V1. The framework of the V1 is made up entirely of commonly found mild steel components. My materials are cut by the steel distributer to predetermined dimensions. Raw stock in the form of 11 gauge steel sheet metal, precut to 12″ by 12′ sheets, is used. Raw stock also includes 11 gauge sheet metal that is precut to 3″ wide by 12′ long and 2″ wide by 12′ long. Square tube pipe of 1½″ diameter with a 16 gauge wall thickness is precut to 12′. Square tube pipe of 1″ diameter and 0.072″ wall thickness is precut to 12′ lengths. Angle stock 1½″ by 1½″ by ⅛″ thickness is cut in 12′ lengths.

This paragraph describes the cutting of the 11 gauge sheet metal. The 11 gauge sheet metal is cut to specified lengths using an acetylene and oxygen torch. All quantities of parts listed here forth will be for the construction of one complete V1. The following lengths are cut from the 12″ wide 11 gauge sheet metal: one piece is cut to 45″ long, one piece will be cut to 24″ long, one piece will be cut to 18″ long, and one piece will be cut to 15″ long. There are 2 pieces cut 4½″ wide and 5″ long. The 3″ wide sheet metal is cut into 4 pieces to provide 3″ by 3″ squares. The 2″ wide sheet metal stock is cut into 4 pieces of 4″ long and 1 piece 18″ long. Bench grinders, hand grinders, and files are extensively used to round and smooth edges so that sharp points and cutting edges are eliminated. The filing and cleaning techniques are employed on all finished pieces of metal.

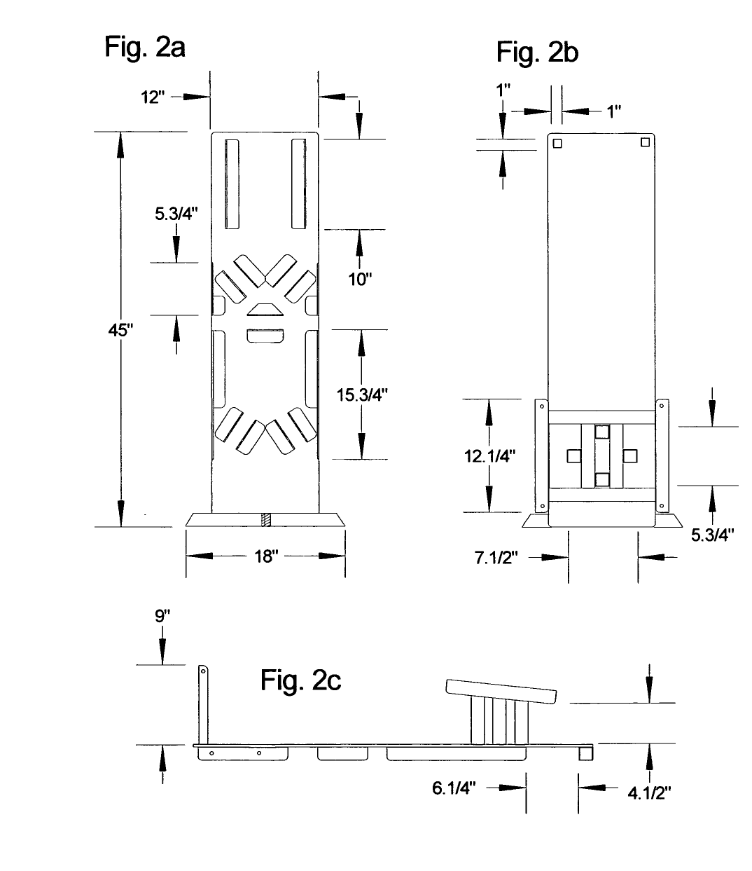

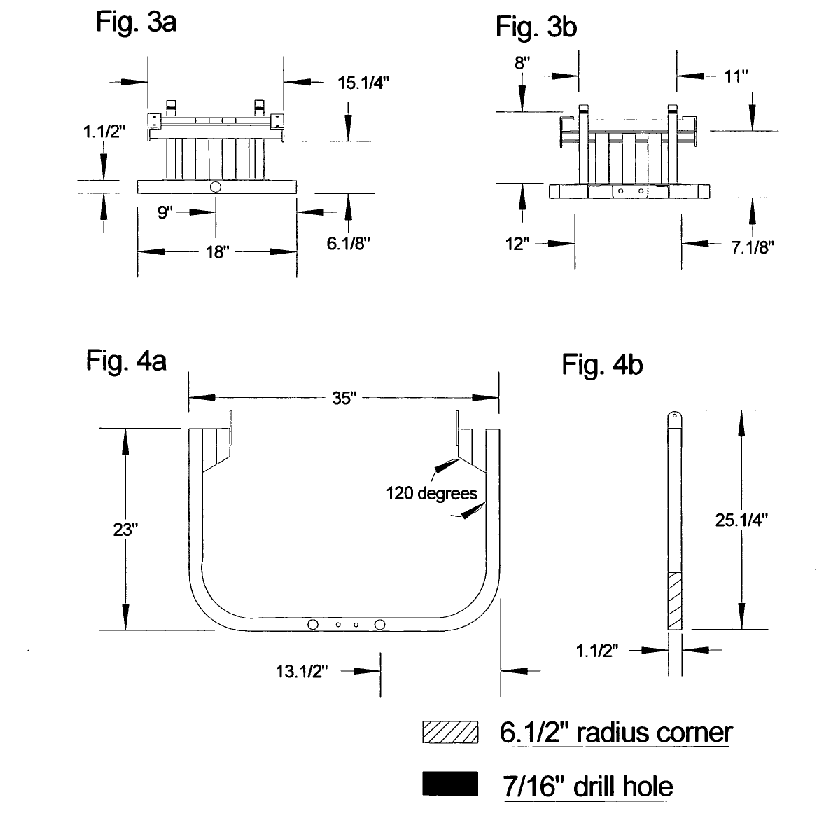

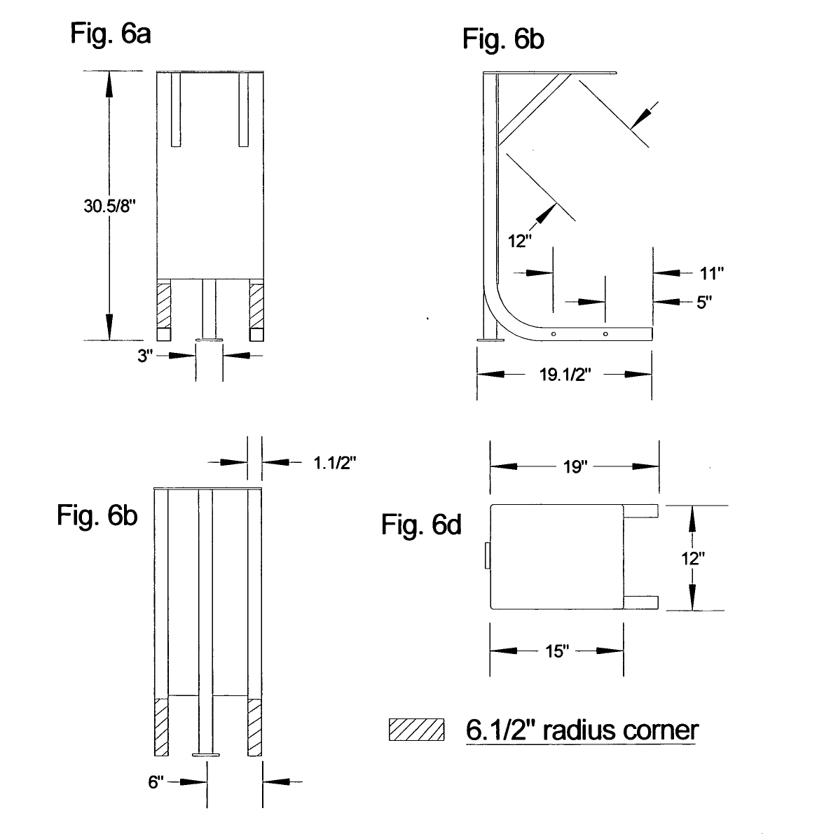

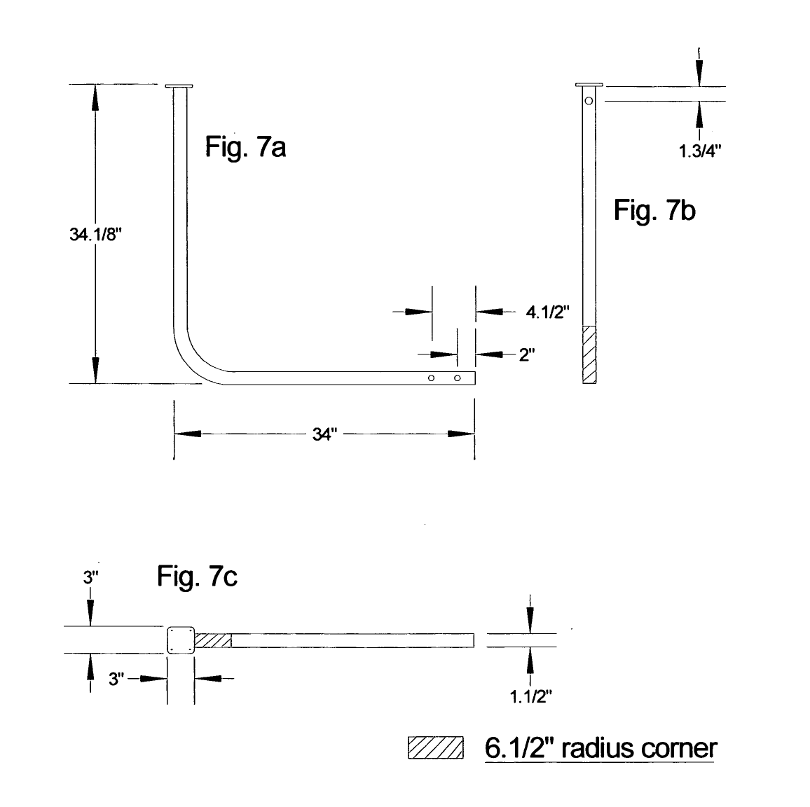

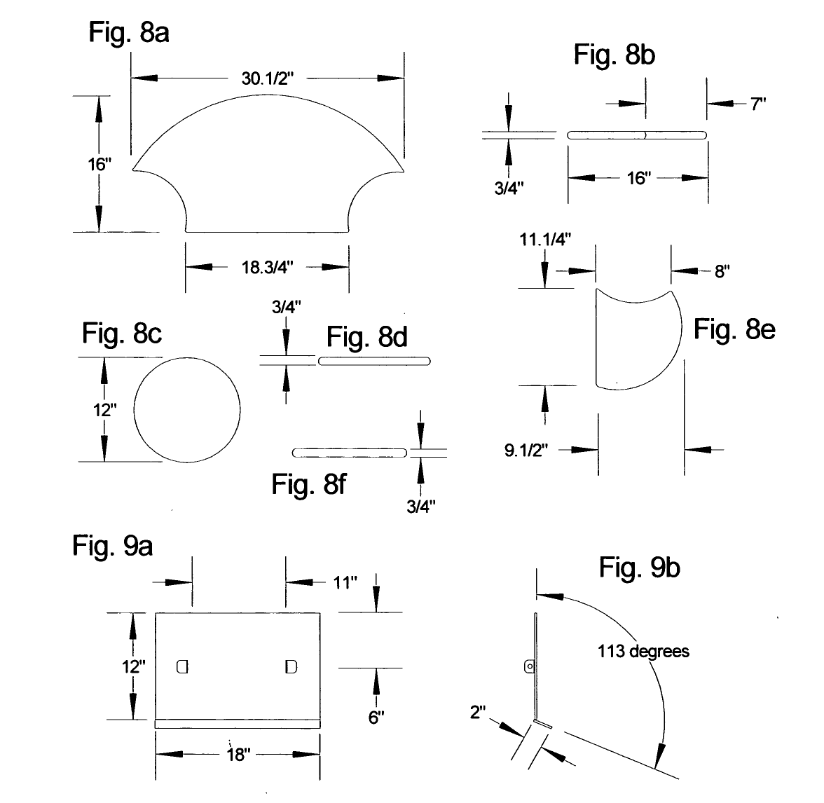

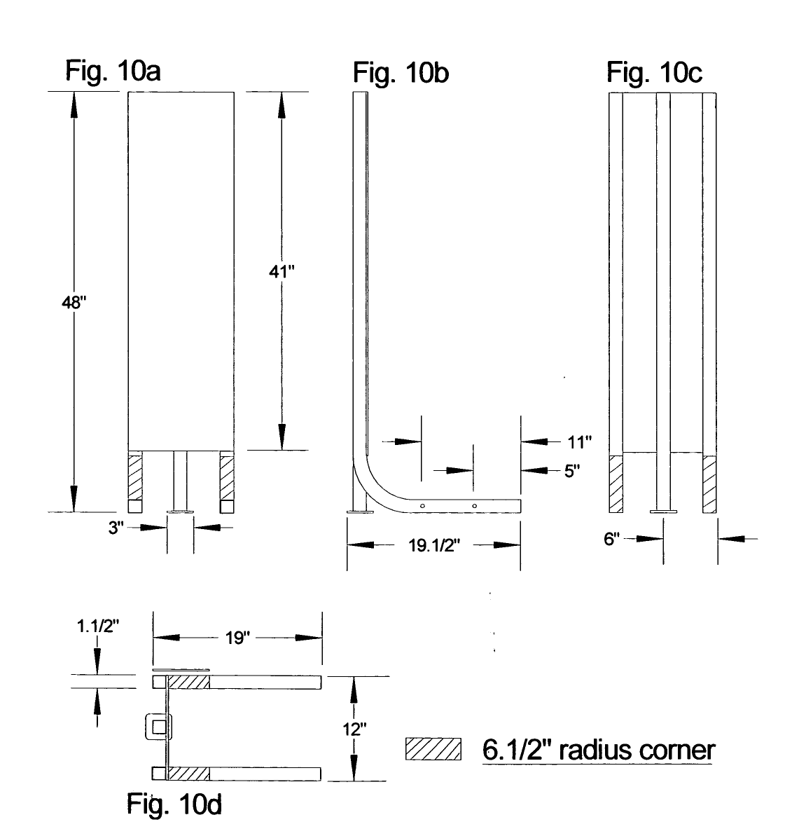

This paragraph describes the cutting of the 1½″ by 1½″ 16 gauge tube. All tubing cuts are made using a circular metal cutting miter chop saw. There are four upright speaker support tubes and two monitor support tubes that are initially rough cut to a 6′ length. The desk support tube is initially cut to a 7′ length. There is one piece cut to a 30⅜″ length. There are six pieces cut to a 6½″ length. There are four pieces cut to a 12″ length. There are two pieces cut to a 5″ length. There is one piece cut to a 22¾″ length. There are two pieces cut to a 15″ length. There are two pieces cut to a 5″ length with one of the ends having a 0 degree straight cut and the other end having a 30 degree miter cut. Two pieces are cut to a 4¼″ length also with one of the ends having a 0 degree straight cut and the other end having a 30 degree miter cut. There is one piece cut to an 18″ length with 55 degree miter cuts applied on either end. The miter cuts oppose one another. This paragraph describes the cutting of the 1″ by 0.072″ wall thickness square tube. There are two pieces cut 12″ long with 45 degree miter cuts on both ends. There are two pieces cut to 9″ length. This paragraph describes the cutting of the 1½″ angle stock. There are nine pieces cut to 4″ long. A piece is cut 4″ long and the ends are clipped at a 45 degree angle. There are two pieces cut to 5¾″ long. There are two pieces cut to 12¼″ long. There are two pieces cut to 15¾″ long. There are two pieces cut to 10″ long. There are two pieces cut to 2″ long. There are two pieces cut to 5″ long. All the cut pieces can now be used for further assembly of the V1. Please refer to FIG. 2A. The base unit is assembled using the 45″ long by 12″ wide sheet of the 11 gauge metal. The 1½″ square tube cut 18″ long and having 55 degree miter cuts is welded, with three equally placed welds, to the base. This piece is centered so the miter cuts protrude from each side equal distance and the angles slope inward toward the center of the base. A standard MIG welder is used employing 0.030″ mild steel wire and argon shielding gas for all welds on the unit. The angle stock cut to the 4″ lengths are drilled with two holes each, and I refer to these pieces as brackets. The holes are drilled 7/16″ diameter centered 2½″ apart. These pieces are welded, with two welds each, to the base to provide the mounting brackets for all the square tube pieces. The two angle sections measuring 10″ long are drilled so the two holes are 1″ and 7″ from one end to provide the mounting bracket for the monitor support/flat screen support. The monitor support brackets receive 5 side welds. The exact positioning of these parts is demonstrated on the accompanying draft diagram FIG. 2a. The pieces of angle cut to 5½″ and 15½″ long are positioned on the sides of the base and welded to form a skirt in between the tubes. These angle pieces are for asthetics and add rigidity and are custom cut to fit. The base is then turned over so the mounting brackets are down as in FIG. 2b. The seat support uprights, four each being 6½″ long, are positioned and welded on three sides to the base starting 7″ from the back of the base. The two pieces of 1″ square tube being 9″ long are drilled with one hole each of 7/16″ diameter. The holes are 1″ down from the top of the tube and the tube is rounded and filed. The 1″ upright foot rest supports are positioned ½″ in from the front and side edges and welded on all sides into position straight vertical so the top holes face in toward the center line of the base. The seat mounting bracket will accept standard aftermarket car seat configurations. The seat mounting bracket is welded together using two of the 15″ by 1½″ diameter square tubes and two of the 12¼″ angle brackets drilled with ½″ holes. Two of the 6½″ by 1½″ square tube pieces are used as well. The seat bracket is positioned to be centered over the four upright supports and angled back so the rear of the bracket is 6⅛″ above the base plate and the front of the bracket is 7⅛″ above the base plate. The bracket is welded into position. A hand operated draw style bender is employed to form the 90 degree bends on the speaker support tubes and the desk support tube. The dies on the bender are specific to the task of forming 1½″ square tube. All bends are radius to 6½″. The six pieces of 6′ by 1½″ tube are bent 90 degrees in the middle and then cut to be the exact length and height of 34″ to form the four speaker support stands as seen in FIG. 7a. The other two are cut to exactly 19″ long and 30½″ inches tall to form the monitor upright support tubes as seen in FIG. 6b. The desk support tube is made in a similar manner using the 7′ by 1½″ square tube. The first 90 degree bend is made then the tube is moved in on the bending machine to form the second 90 degree bend. The bends form a “U” shape 35 inches wide as seen in FIG. 4a. The “U” shaped part is then drilled with the ½″ holes for mounting and the 1″ diameter holes provided for wire passage. It is then trimmed to the exact height of 23″.

The speaker support tubes each have a 3″ square sheet metal plate welded on one end as seen in FIG. 7c. There are small ⅛″ holes drilled in these plates for speaker mounting. ½″ holes are drilled on the opposite end of the tube so it will stand up vertically when mounted to the base. An additional ¾″ diameter hole is drilled 1¾″ below the top plate to allow the passage of speaker wires.

The desk support is constructed with the “U” shaped tube using the four pieces of 1½″ square tube that are 4″ and 5″ long and having a 30 degree miter cut on one end as seen in FIG. 4a. The parts are arranged together so that 4″ and 5″ tubes form the mounts on the top. The 30 degree cuts align and slope up and inward from the upright tube. The 4″ long by 1½″ pieces of the 11 gauge sheet metal are drilled and custom shaped. This final piece is welded into place making the location/pivot point to mount the rest of the desk unit.

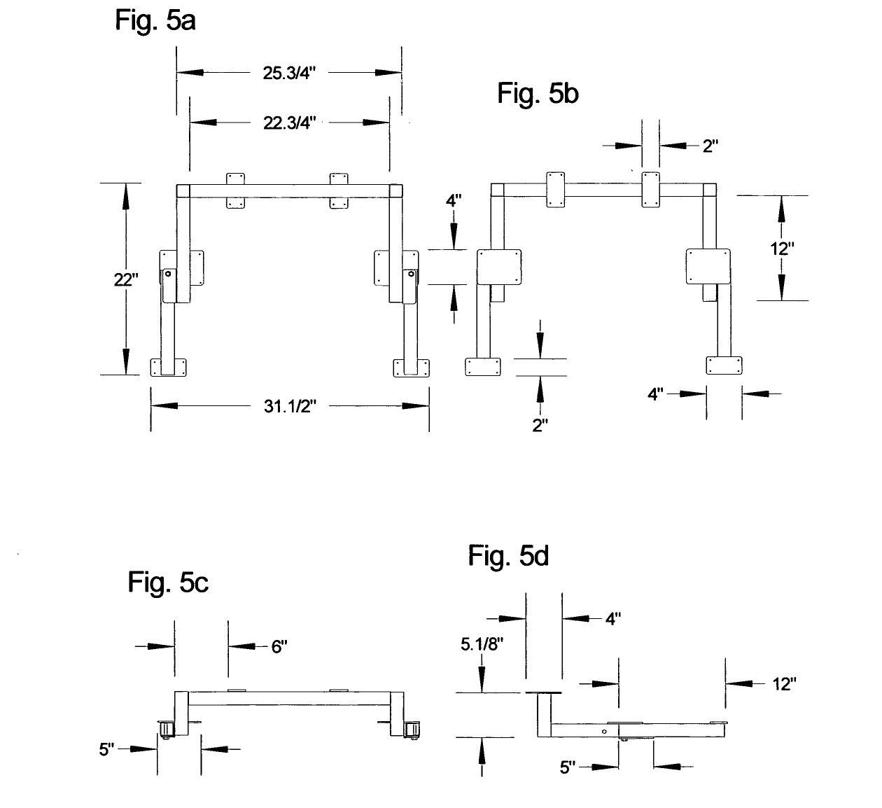

The arm rest unit is displayed in FIG. 5a, FIG. 5b, FIG. 5c and FIG. 5d. The arm rest unit is constructed by welding the 22¾″ by 1½″ square tube and two pieces of square tube that are 5″ by 1½″. Two pieces of 12″ long by 1½″ square tube are added by welding. Two pieces of sheet metal 4½″ by 5″ are welded in place. 5″ long angle support brackets all get welded. The hinge pin is drilled from top to bottom through all tube and angle parts at once. Pins are added at the pivot point and welded into place. 2″ by 4″ sheet metal desk mount plates are drilled for the wood top placement and screws can secure the tops through ⅛″ drill holes. They are all welded into place to support all the wooden desk parts.

The monitor stand can be seen in FIG. 6a, FIG. 6b, FIG. 6c and FIG. 6d. Construction begins by welding the 24″ by 12″ sheet metal piece and the 15″ by 12″ sheet metal piece in a 90 degree angle. Radiused tubes that were cut to 19″ by 30½″ are welded to the 24″ sheet metal piece. The 30⅛″ by 1½″ square tube is added centered between the bent support tubes as a means to strengthen the monitor stand. A 3″ by 3″ sheet metal pad is welded onto the bottom of the center down post to prevent floor damage. The two 12″ by 1″ tubes cut with 45 degree ends are now welded in place.

The foot rest is constructed with the 18″ by 12″ and 18″ by 2″ pieces of 11 gauge mild steel as seen in FIG. 9a and FIG. 9b. The lower lip is angled downward using a ½″ deflection from perpendicular alignment. 2″ angle brackets are drilled and welded into position on the front of the foot rest. These two brackets are spaced 11″ apart and centered on the 18″ by 12″ plate.

All metal parts are sand blasted to white finish standards. All steel parts are cleaned and prepared for the multi-stage paint process. Premium automotive quality acid etch primer is applied. A value shade sealer is then applied to ensure the surface is suitably smooth for color paint. Two coats of urethane enamel are applied before wet sanding with 600 and 1000 grit sandpaper. The final coat of urethane enamel is applied and closely inspected. Two coats of urethane clear are applied then wet sanded. A final two coats of urethane clear are applied.

The tops are constructed from a variety of wood choices. Medium density fiberboard wrapped with a black rubber vinyl is one example. Wood tops are constructed with a band saw, a router, and a sander.

The V1 is now ready for final assembly. It is assembled using standard american thread 7/16″ nuts, bolts, and washers. The wooden tops are mounted using standard 1/16″ by ½″ wood screws.

1. What I claim as my invention is the V1, the complete design of the V1, and the specific design style of the V1.
